(19) United States
(12) Patent Application Publication
(10) Pub. No.: US 2025/0268117 A1
(43) Pub. Date: Aug. 28, 2025

(54) IMPROVED CONNECTION METHOD, CONNECTION SYSTEM AND RADIO-CONTROLLED VEHICLE

(71) Applicant: MDB SRL, LANCIANO (CH) (IT)

(72) Inventor: Mario Di Biase, LANCIANO (CH) (IT)

(73) Assignee: MDB SRL, LANCIANO (CH) (IT)

(21) Appl. No.: 18/857,617

(22) PCT Filed: Apr. 19, 2023
(86) PCT No.: PCT/IB2023/053989

§ 371 Date: Oct. 17, 2024

(30) Foreign Application Priority Data
Apr. 20, 2022 (IT) 102022000007829

(51) Int. Cl. A01B 59/06; E02F 3/36; E02F 9/20

(52) U.S. Cl. CPC A01B 59/064; E02F 3/3663; E02F 9/205

(57) ABSTRACT

The present invention is related to a method for coupling an attachment to a radio-controlled vehicle by means of a connection system having a support, an attachment-holder unit and a coupling unit. The support is fixed to a radio-controlled vehicle and the attachment-holder unit is fixed to the attachment. The coupling unit is automatically operable, in particular it is remotely operable, without the direct intervention of an operator to selectively connect or disconnect the support and the attachment-holder unit to/from each other.

### CROSS-REFERENCE TO RELATED APPLICATIONS

This Patent Application claims priority from Italian Patent Application No. 102022000007829 filed on Apr. 20, 2022 the entire disclosure of which is incorporated herein by reference.

### TECHNICAL FIELD

The present patent application for invention relates to an improved connection method, connection system and radio-controlled vehicle.

In particular, the present invention relates to a connection method and a connection system for remotely coupling or releasing, selectively and automatically, an attachment to a radio-controlled vehicle.

A radio-controlled vehicle according to the present invention can be, for example, a green maintenance vehicle (for mowing terrains, road edges, ditches or the like) or a soil moving vehicle, such as a shovel or mini-shovel. Some examples of known reference radio-controlled vehicles are the vehicles marketed by MDB SRL and named GREEN CLIMBER or MP100.

Advantageously, the present invention relates to a method which allows remotely coupling and/or releasing an attachment to a radio-controlled vehicle.

Advantageously, the present invention relates to a connection system and a radio-controlled vehicle capable of being remotely controlled and of working safely even in extreme conditions, for example also on slopes with gradients greater than 60°.

### PRIOR ART

It is known that radio-controlled vehicles are utilized for handling and operating attachments with respect to a supporting plane. It is known to install on a radio-controlled vehicle an attachment such as, for example, a shovel or a shredder (which includes a rotor from which knives protrude capable of shredding grass, shrubs, stumps and logs up to 50 cm in diameter), or the like.

Also known are radio-controlled vehicles, for example of the type GREENCLIMBER or MP100, produced by MDB SRL. Such types of radio-controlled vehicles advantageously allow working safely on very steep slopes and even with gradients of 60°. The advantage of utilizing this type of radio-controlled vehicles is that the operator can operate the radio-controlled vehicle remotely and safely.

Attachments, such as shredders or shovels, of known type are fixed to the radio-controlled vehicle by means of fixed connection systems. For example, the shredders are connected by means of an axle shaft. However, the axle shaft can be subject to breakage, due to the high stresses that can develop thereon during use.

The fixed connection systems of known type have the disadvantage of providing connections, for example bolted connections, which require the direct physical intervention of the operator in order to fix or free the attachment to/from the radio-controlled vehicle. This is particularly risky in case of jamming of the attachment (e.g., jamming of the shredder) during its operation and in dangerous conditions (on high gradients and/or under the application of high loads). In fact, in such conditions it is absolutely not recommended that the operator physically approaches the vehicle and the attachment for a direct intervention.

### DESCRIPTION OF THE INVENTION

The object of the present invention is to provide a method and a system for connecting the attachment to a radio-controlled vehicle which allows the operator to work safely even in the event of breakdowns and malfunctioning of the attachment.

According to the present invention, a method is provided according to what claimed in the appended claims.

According to the present invention, a connecting system is provided according to what claimed in the appended claims.

According to the present invention, a radio-controlled vehicle is provided according to what claimed in the appended claims.

### BRIEF DESCRIPTION OF THE DRAWINGS

The invention will now be described with reference to the accompanying drawings, which illustrate a non-limiting example embodiment thereof, wherein:

FIG. 1 is a view of a radio-controlled vehicle according to the present invention in operating configuration.

FIG. 2 illustrates a detail of FIG. 1 with some parts removed for clarity;

FIG. 3 is an exploded view of the detail of FIG. 2;

FIG. 4 illustrates the detail of FIGS. 2 and 3 in a first operating configuration;

FIG. 5 is a section view according to plane V of FIG. 2;

FIG. 6 is similar to FIG. 4 and illustrates the detail of FIG. 2 in a second operating configuration;

FIG. 7 illustrates a variation of a radio-controlled vehicle according to the present invention in an operating configuration;

FIG. 8 illustrates a detail of FIG. 7 with some parts removed for clarity;

FIG. 9 is a side view of the detail of FIG. 8;

FIG. 10 is the section view according to line X of FIG. 9.

### PREFERRED EMBODIMENT OF THE INVENTION

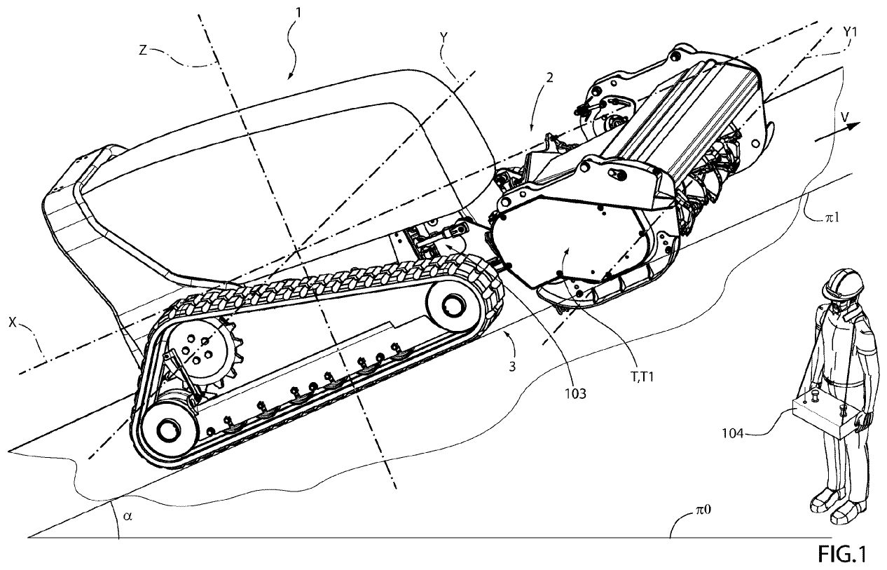

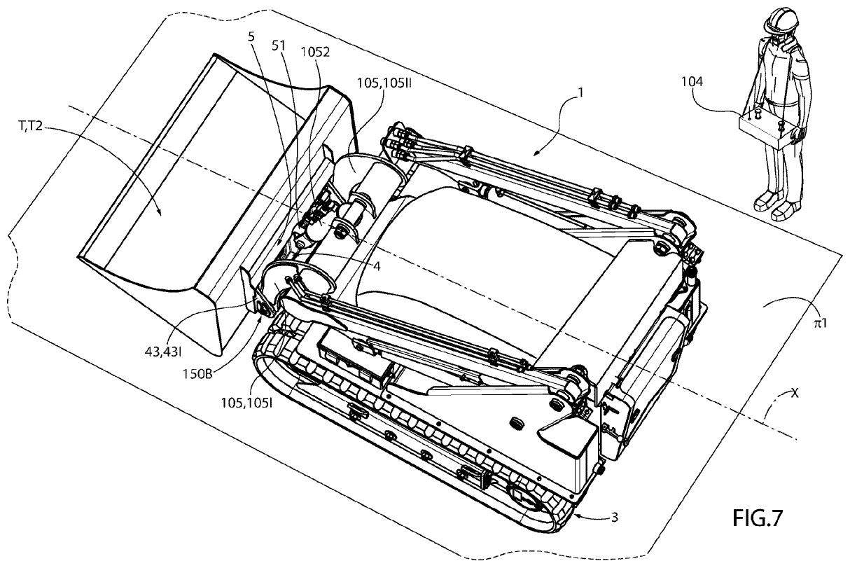

In FIG. 1, a radio-controlled vehicle 1 and an attachment T are illustrated in use, in the illustrated example a forestry shredder T1. Without losing its generic character, the attachment T can be of any type. For example, according to the variation illustrated in FIG. 7, the attachment T is a shovel T2.

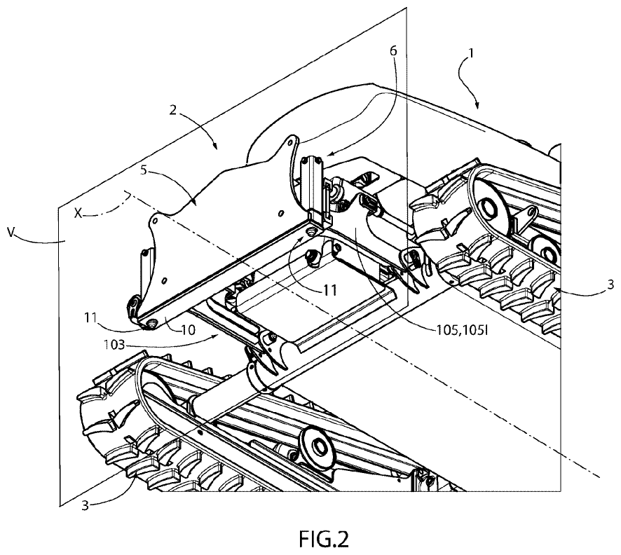

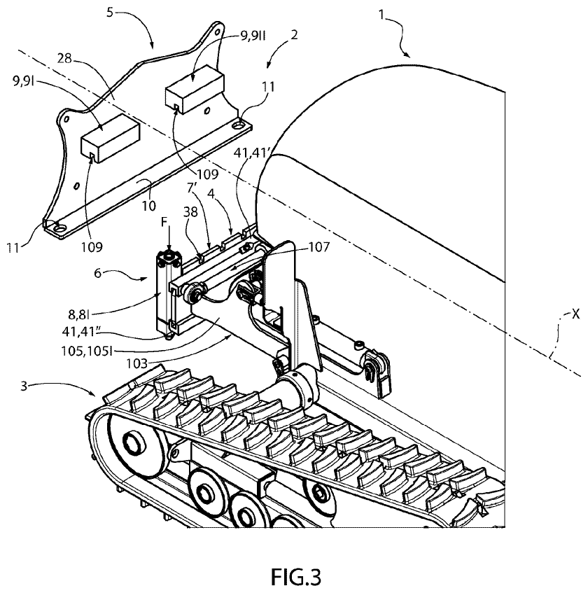

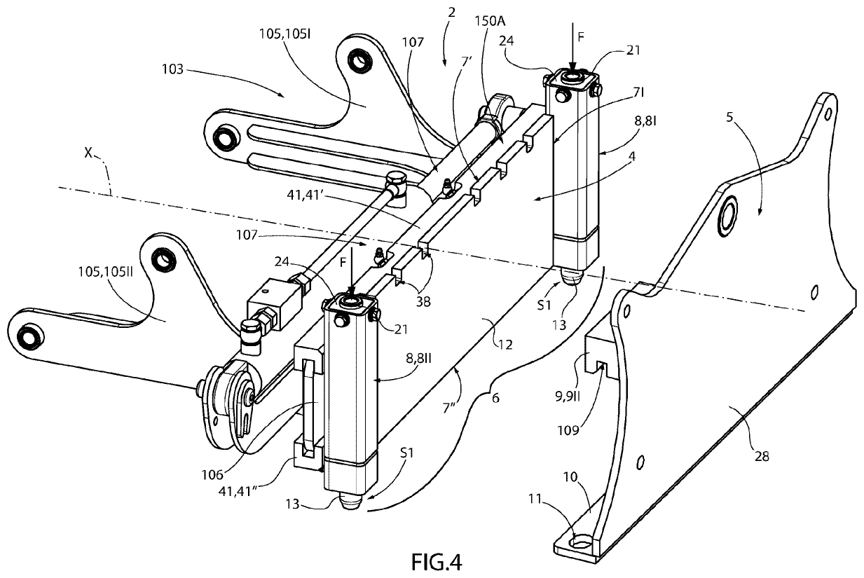

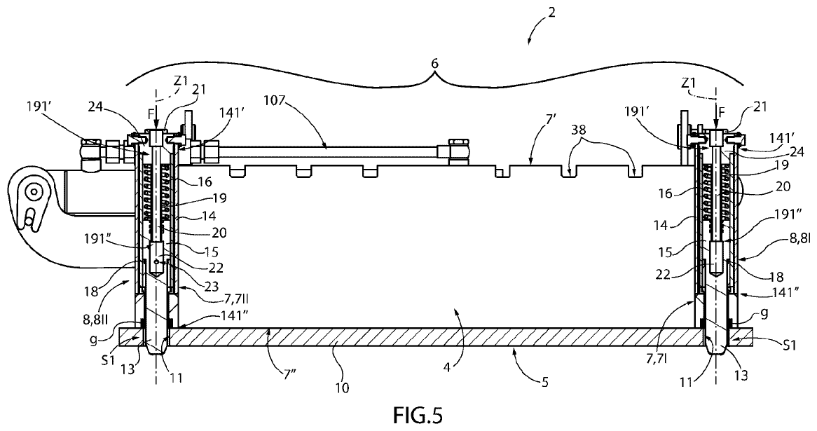

FIGS. 2 to 6 further more specifically illustrate a connection system 2 according to the present invention. The connecting system 2 is configured to connect the radio-controlled vehicle 1 and an attachment T to each other.

Advantageously, the connection system 2 is automatic. In other words, the connection system 2 is configured to be operated without the direct intervention of an operator, as it will be better illustrated in the following.

The radio-controlled vehicle 1 comprises rolling bodies 3 and is configured to be able to move on a supporting plane π1, which can have a gradient α (i.e. is inclined by an angle α) also greater than 60°, with respect to a horizontal plane π0. According to the illustrated example, the rolling bodies 3 are tracks, according to non-illustrated variations, the rolling bodies 3 can be of different type, for example they can be wheels.

By way of non-limiting example, the radio-controlled vehicle 1 can be a high-performance vehicle and of the type produced by the company MDB S.R.L. under the trade name “GREEN CLIMBER” (FIG. 1) or MP100 (FIG. 7).

According to what illustrated in FIG. 2, the radio-controlled vehicle 1 respectively has:
a longitudinal axis X, also known as roll axis and substantially parallel to the supporting plane π1 of the radio-controlled vehicle 1;
a vertical axis Z perpendicular to the supporting plane π1 and also known as yaw axis; and
a transverse axis Y, perpendicular to both the longitudinal axis X and the vertical axis Z and also known as pitch axis.

The same reference system of the axes X, Y, Z is utilized mutatis mutandis as reference system of the relative attachment T when connected to the radio-controlled vehicle 1.

The radio-controlled vehicle 1 comprises a frame 103, a motor assembly (of known type and not illustrated), a hydraulic assembly (for the pressurized oil inlet), a kinetic unit (in the illustrated case formed by the track assembly 3), and a remote control 104 configured to remotely operate said conveyor 1. In particular, said remote control 104 operates, in use, the motor assembly and/or the hydraulic assembly and/or the kinetic unit 4.

Advantageously, the hydraulic assembly is operable by means of the remote control 104. Advantageously, the hydraulic assembly is configured to operate the connection system 2 by means of the pressurized oil flow F, as it will be better illustrated in the following.

In the following and in FIGS. 1-6, suffixes I and II are utilized to indicate the left side and the right side, respectively; whereas, suffixes ′ and ″ are utilized to indicate the upper side and the lower side, respectively. The terms such as front, rear, top, bottom or the like are utilized with reference to the normal operation of the radio-controlled vehicle 1 in the forward direction v on the supporting plane π1.

According to what illustrated in FIGS. 2 to 6, the connection system 2 comprises a support 4, an attachment-holder unit 5 and a coupling unit 6 interposed between the support 4 and the attachment-holder unit 5.

The support 4 is integral with the radio-controlled vehicle 1.

By way of non-limiting example, the support 4 is fixed to the frame 103 of the radio-controlled vehicle 1.

According to the example illustrated in FIGS. 2 to 6, the frame 103 of the vehicle 1 comprises two arms 105I and 105II, which are substantially parallel to the roll axis X, and a plate 106 which is fixed to the two arms 105I, 105II and is substantially perpendicular to the roll axis X.

According to the example illustrated in FIGS. 2 to 5, the support 4 comprises a coupling unit 150A which is configured to be fixed to the plate 106 of the frame 103. According to the illustrated example, the coupling unit 150A is configured to make a prismatic kinematic pair, i.e. a pair which allows the relative translation, with the plate 106.

According to the example illustrated in FIGS. 2 to 5, the support 4 comprises a foil 12 having a rectangular shape. The coupling unit 150A comprises an upper slide 41′ and a lower slide 41″ fixed to the foil 12.

According to the illustrated example, the slides 41′ and 41″ have a U-shaped profile and are opposed to each other so as to be fitted, in use, on two opposed edges of the plate 106. Preferably, the support 4 and the plate 106 are reciprocally movable along a direction parallel to said slides.

According to the illustrated example, the frame 103 comprises a drive 107 which is connectable to the support 4 and is configured to translate the support 4 with respect to the plate 106. According to the illustrated example, the drive 107 is a hydraulic cylinder. According to a variation not illustrated, the connection system 2 can comprise fixing means (of known type and not illustrated) for fixing said plate 106 and said support 4 together in a given reciprocal position.

The foil 12 has a substantially rectangular perimeter and has an upper edge 7′ and a lower edge 7″, which are the side edges having larger dimensions and are parallel to the transverse axis Y of the radio-controlled vehicle 1. The foil 12 has a left edge 7I and a right edge 7II, which are the side edges of smaller dimensions parallel to the vertical axis Z of the radio-controlled vehicle 1.

The upper edge 7′ has upwardly open U-shaped grooves 38. The grooves 38 are references for the attachment-holder unit 5.

Advantageously, the coupling unit 6 is automatic. In other words, the coupling unit 6 is remotely operable without the direct intervention of the operator.

According to the illustrated example, the coupling unit 6 is hydraulically operated. According to variations not illustrated, the coupling unit 6 can be operated by an operating system selected from a group of operating systems of a different type, such as: electric, pneumatic, mechanical, electromagnetic or equivalent systems.

According to the illustrated example, the coupling unit 6 is integral with the support 4. In other words, when the attachment T is released from the radio-controlled vehicle 1, the attachment unit 6 remains on board of the radio-controlled vehicle 1. According to a variation not illustrated, the coupling unit 6 can be connected to the attachment T, in this case when the attachment T is released from the radio-controlled vehicle 1, the coupling unit 6 remains integral with the attachment T or is independent.

The attachment-holder unit 5 comprises, in turn, a foil body 28 which, in use, is substantially perpendicular to the longitudinal axis X and parallel to the support 4. The foil body 28 has a variably developing profile which can be of any shape and size.

The attachment-holder unit 5 further comprises an abutment element 9 which is in contact, in use, with an edge 7 of the support 4. The abutment element 9 is configured to form a shape coupling and/or interference fit with the support 4.

According to the example illustrated in FIGS. 2 to 6, the attachment-holder unit 5 comprises two abutment elements 9 in contact, in use, against the upper edge 7′ of the support 4. More specifically, the abutment unit 9 comprises an abutment element 9I (left) and an abutment element 9II (right) which come into contact with two respective portions of the upper edge 7′ of the support 4. Without losing generality: the number and the distribution of the abutment elements 9 can be different from those illustrated. Each abutment element 9I and 9II is configured to form a shape coupling and/or an interference fit with the support 4.

According to the illustrated example, each abutment element 9 has a U-shape with a groove 109 facing the interaction unit 10. Each groove 109 is configured to allow the insertion and the housing of a respective portion of the support 4 to allow the coupling between the support 4 and the attachment-holder unit 5. Inside the groove 109 a respective portion of the support 4 is housed, when the attachment-holder unit 5 and the support 4 are coupled together.

The attachment-holder unit 5 further comprises an interaction unit 10 with the coupling unit 6. According to the illustrated example, the interaction unit 10 comprises a foil having seats 11. According to variations not illustrated, the interaction unit 10 can be different, for example it can have a different number and shapes of foils 10. According to the illustrated example, the seats 11 are two, according to a variation not illustrated, the interaction unit 10 can have a single seat 11 or three or more seats 11.

The coupling unit 6 comprises, in turn, a mechanism 8 which is configured to selectively couple/release the support 4 to/from the attachment-holder unit 5. According to the example illustrated in FIGS. 2 to 6, the coupling unit 6 comprises a left mechanism 8I and a right mechanism 8II which are fixed to the left edge 7I and, respectively, to the right edge 7II of the support 4. The number, the orientation and the distribution of the mechanisms 8 can be different from those illustrated. For example, the coupling unit 6 can comprise a single mechanism 8 or three or more mechanisms 8.

According to the illustrated example, the two mechanisms 8I and 8II are substantially equal to each other. According to a variation not illustrated, the mechanisms 8I and 8II can be different from each other.

Each mechanism 8 is configured to cooperate, in use, with the interaction unit 10, so as to constrain the support 4 to the attachment-holder unit 5. In particular, each mechanism 8 is fixed to the support 4 and is interposed between the abutment element 9 and the interaction unit 10. In this way, the connection system 2 is particularly compact and each mechanism 8 is arranged in a position protected from external agents and stresses. Advantageously, each mechanism 8 is shielded by the support 4 and, in other words, is placed on the internal side of the support 4, i.e. the side that in use faces the radio-controlled vehicle 1. In this way, each mechanism 8 is interposed between the support 4 and the radio-controlled vehicle 1 during use.

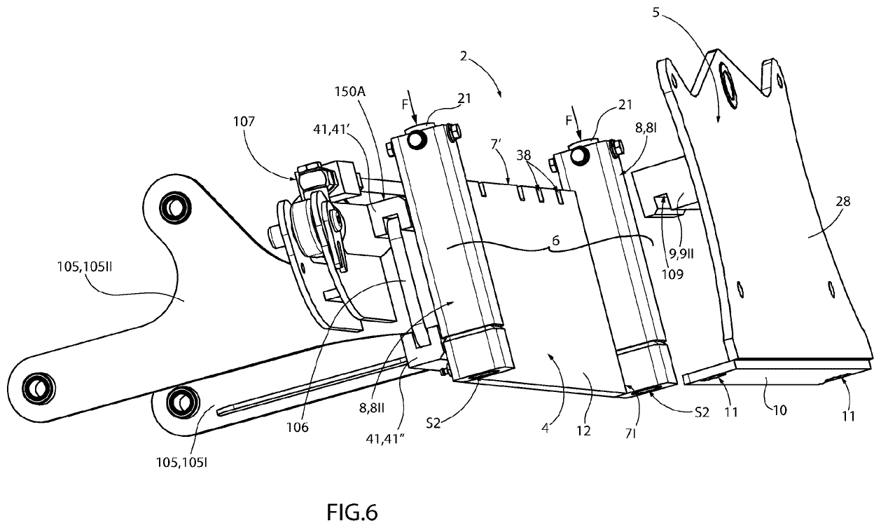

According to the illustrated example, each mechanism 8 comprises a pin 13, which is movably mounted from a fixing position S1 (FIGS. 2 to 5) to a release position S2 (FIG. 6), and vice versa.

According to the example illustrated in the figures, the mechanisms 8 are push type single-acting cylinders. Advantageously, each mechanism 8 is fed from above and coaxially, as it will be better illustrated in the following. Each mechanism 8 comprises a hollow body 14, having a longitudinal axis Z1, an upper end 141′ and a lower end 141″.

The mechanism 8 further comprises a piston 15, which is slidably mounted inside the hollow body 14 along the longitudinal axis 21, and a spring 16. The spring 16 is installed inside the hollow body 14 so as to reposition the piston 15 in a predefined position.

According to the illustrated example, the spring 16 acts on the piston 15 so as to push the pin 13 into the fixing position S1.

The pin 13 is fixed to the piston 15 and moves along the longitudinal axis Z1 integrally with the piston. According to the illustrated example, the mechanism 8 is fixed to the support 4 so that its longitudinal axis 21 is parallel to the vertical axis Z of the radio-controlled vehicle 1.

More specifically, the hollow body 14 has an expansion chamber 18 which is adapted to receive, in use, pressurized oil F from an oil inlet of the hydraulic assembly of the radio-controlled vehicle 1, as it will be better illustrated in the following. The piston 15 is interposed along the longitudinal axis z1 between the expansion chamber 18 and the spring 16.

According to the illustrated example, advantageously, each mechanism 8 comprises a stem 19 which is inserted inside the hollow body 14 and is configured to feed the pressurized oil F inside the expansion chamber 18. The stem 19 is coaxial to the longitudinal axis Z1. The stem 19 is mounted fixed and cantilevered along the hollow body 14. The stem 19 is substantially a tubular body crossed by a channel 20 which allows the pressurized oil F to flow. The stem 19 has an upper end 191′ and a lower end 191″. The stem 19 comprises a fitting 21 for fluidly connecting the channel 20 at the upper end 191′ to a relative pressurized oil inlet F (of known type and not illustrated) of the radio-controlled vehicle 1.

In this way, advantageously, the feeding of the pressurized oil F to the expansion chamber 18 takes place inside the hollow body 14, in particular along the longitudinal axis Z1. In other words, no mouths are present at the sides of the hollow body 14 for the inflow of pressurized oil F within the expansion chamber 18. This makes the mechanism 8 compact and safe, moreover it allows having a large continuous and smooth surface for the fixing, for example by welding, to the support 4.

The piston 15 has a central chamber 22. The piston 15 is fitted on the stem 19. The piston 15 and the stem 19 are reciprocally movable. The central chamber 22 of the piston 15 is configured to house, at least in part, the stem 19. According to the illustrated example, the piston 15 and the pin 13 protrude along the longitudinal axis Z1 from the lower end 191″ of the stem 19.

The central chamber 22 is closed along the longitudinal axis Z1 by the body of the pin 13. The central chamber 22 has a side opening 23 which puts the central chamber 22 in fluid communication with the expansion chamber 18. The mechanism 8 further comprises gaskets g for hermetically closing the mechanism 8 and preventing oil leaks on the outside. The type and method of installations of the gaskets g are of known type and illustrated in a schematic way.

Advantageously, the hollow body 14 has a section on the plane X-Y of polygonal shape. According to the illustrated example, the section is substantially square with bevelled edges. According to variations not illustrated, the polygonal section of the hollow body can have a different number of sides (e.g., pentagonal, hexagonal, etc.). The polygonal section of the hollow body 14 allows having smooth sides with a surface sufficiently extended for obtaining a stable connection between the hollow body 14 and the support 4. For example, one side of the hollow body 14 is welded to the support 4. In this way, advantageously, a firm connection is obtained capable of to withstand fatigue also at high stresses, such as those which could develop during use between an attachment T (for example a shredder) and the radio-controlled vehicle 1. Advantageously, the mechanism 8 comprises a cap 24 which is placed closing the upper end 141′ of the hollow body 14. The cap 24 has a seat for positioning and housing the fitting 21. The cap 24 has a section on the plane X-Y having a polygonal shape such as to form a shape coupling and/or an interference fit with the upper end 141′ of the hollow body 14. The cap 24 is simple to manufacture and easy to mount. Thanks to the polygonal shape of the cap 24 and of the hollow body 14, it is possible to utilize interference fits, for example connections by means of screws, for each side of the cap 24. In this way, advantageously, it is possible to obtain a stable and firm connection between the cap 24 and the hollow body 14.

Each mechanism 8 of the above-described type has the advantage of being simple and cost-effective to manufacture and easy to mount. In this way, advantageously, the maintenance operations are particularly facilitated. In use, the support 4 is fixed to the frame of the radio-controlled vehicle 1 and each mechanism 8 is connected to the hydraulic assembly (of known type and not illustrated) of the radio-controlled vehicle 1. The operator acting on the radio controller selectively remotely adjusts the activation and the deactivation of the coupling unit 6 to selectively fix/release the attachment-holder unit 5 to/from the support 4. In other words, the attachment-holder unit 5 can be connected to the support 4 without the direct intervention of the operator.

Advantageously, the fitting 21 of each mechanism 8 is connected to a pressurized oil inlet F. Advantageously, an operator acting on the radio controller 104 can selectively interrupt/activate (in a known manner not illustrated) the pressurized oil inlet F to the fitting 21 of each mechanism 8.

In particular, by feeding each mechanism 8 by means of pressurized oil F the piston 15 moves, bringing the pin 13 to the release position S2. By deactivating the pressurized oil inlet F to the mechanism, in particular, by connecting the fitting 21 of each mechanism to an exhaust, the piston 15 is brought back to the fixing position S1 by the pushing action of the spring 16. Advantageously, the operation of each mechanism 8 is function of the flux parameters of the pressurized oil inlet F. For example, the adjustable parameters of the pressurized oil inlet F are pressure and/or flow rate.

Advantageously, each mechanism 8 is a push type single-acting hydraulic cylinder, in this way the pin 13 in the rest position is in the fixing position S1. Therefore, advantageously, the connection between the support 4 and the attachment-holder plate unit 5 is always guaranteed also in the event of breakdowns in the hydraulic assembly.

When the pin 13 is in the release position S2, it is possible to reciprocally move the support 4 and the attachment-holder unit 5. When the pin 13 is in the fixing position S1, the attachment-holder unit 5 is fixed to the support 4.

When the pin 13 is brought to the release position S2, the support 4 can be moved by operating the radio-controlled vehicle 1; in this way it is possible to reciprocally move the support 4 and the attachment-holder unit 5 to couple/decouple them.

By way of example, according to the example illustrated in FIGS. 1 to 6, in order to be able to couple the attachment-holder unit 5 to the support 4, the following steps are carried out:
pressurized oil is fed to each mechanism 8 so as to arrange the piston 15 and, consequently, the pin 13 in the release position S2;
the radio-controlled vehicle 1 is remotely operated so that the upper edge 7′ of the support 4 engages with the abutment elements 9 of the attachment-holder unit 5 to form the shape couplings and/or interference fits; in particular, the support 4 is inserted from below inside the U-shaped seats of the abutment elements 9;
the lower edge 7′' is placed in contact with the interaction unit 10; in particular, the lower edge 7″ is placed above the foil 12 so as to align the pins 13 with the respective seats 11;
once the pins 13 are aligned with the seats 11, each mechanism 8 is unloaded so that the spring 16 pushes the piston 15 and, consequently, the pin 13 in the fixing position S1 and inserting each pin 13 in the respective seat 11.

Once the above procedure has been completed, the attachment-holder unit 5 and the support 4 are coupled, i.e. fixed, together.

In order to release the attachment-holder unit 5 from the support 4, the following steps are implemented:
pressurized oil is fed to each mechanism 8 so as to arrange the piston 15 and, consequently, the pin 13 in the release position S2;
the radio-controlled vehicle 1 is remotely operated so that the support 4 is displaced (translated/rotated-translated) with respect to the attachment-holder unit 5 so as to decouple the upper edge 7′ of the support from the abutment elements 9 and from the interaction unit 10.

Advantageously, the solution described above allows fixing/releasing any attachments T to the support 4 automatically, in other words, without the direct intervention of the operator.

In particular, an operator by means of the radio controller 104 is capable of remotely adjusting both the movement of the radio-controlled vehicle 1 and the activation/deactivation of each mechanism 8.

FIG. 7 illustrates a variation of the radio-controlled vehicle 1 according to the present invention. In FIG. 7, the components in common with the solution described in the foregoing maintain the same reference numerals and are considered comprised therein without repeating them for the sake of brevity.

According to the variation illustrated in FIG. 7, the attachment T2 is a shovel.

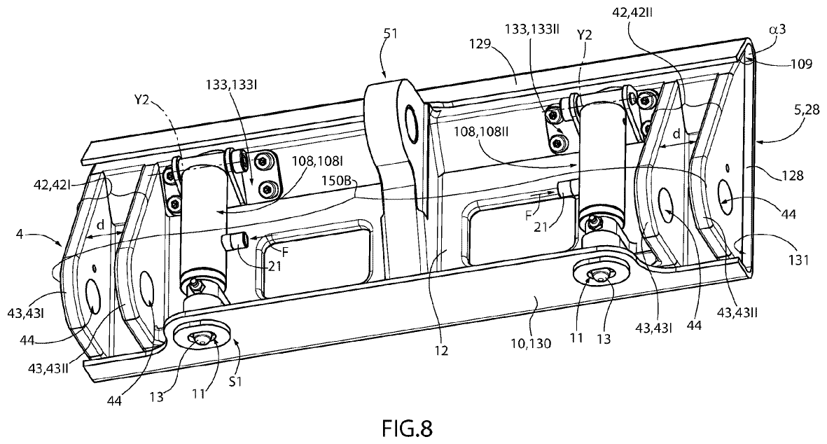

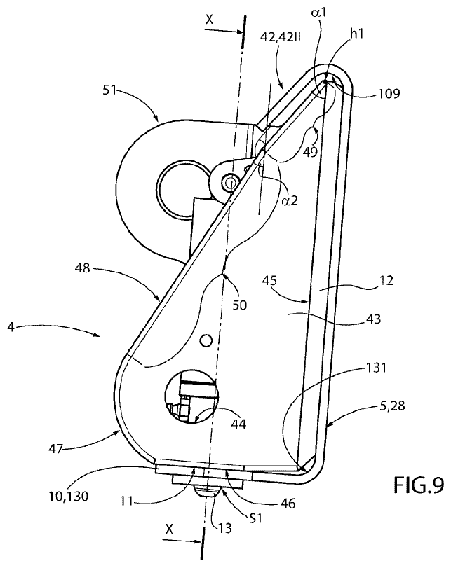

According to the example illustrated in FIGS. 8 and 9, the support 4 comprises a coupling unit 150B which is configured to fix the support 4 to the arms 105 (105I, 105II) of the vehicle 1 (according to the illustrated example, the arms 105 are lifting arms of a mini-shovel) and/or to an actuator 1052 for operating the attachment T2 during use.

According to the example illustrated in FIGS. 8 and 9, the coupling unit 150B is configured to make a rotational kinematic pair, i.e. a pair which allows the relative rotation between the arms 105 and the support 4.

According to the example illustrated in FIG. 8, the coupling unit 150B comprises a left fork 42I and a fork 42II, each of which is configured to form a respective connection hinge with a respective arm 105I, 105II. According to the illustrated example, each fork 42 comprises in turn two cantilevered walls 43 (also indicated in the figure by 43I, 43II to distinguish them from left and right) parallel to each other and which protrude perpendicularly cantilevered from the foil 12. The walls 43 are crossed by holes 44 coaxial to each other and substantially parallel to the transverse axis Y. The distance d between two cantilevered walls 43I and 43II of a same fork 42 is such to be able to house an end of a respective arm 105.

According to what is illustrated in FIG. 9, the shape of each cantilevered wall 43 is substantially a right triangle with: a vertical cathetus 45 in contact with the foil 12; a lower horizontal cathetus 46 protruding perpendicularly from the foil 12; a fitting 47 between the horizontal cathetus 46 hypotenuse The and the 48. cantilevered walls 43 face with the intersection vertex h1 between the vertical cathetus 45 and the hypotenuse 48 facing upward. The hypotenuse 48 is divided into an engagement portion 49 and an intermediate portion 50. The intermediate portion is interposed between the engagement portion 49 and the fitting 47. The engagement portion 49 is interposed between the intermediate portion 50 and the vertical cathetus 45. The engagement portion 49 is inclined by an angle α1 with respect to the foil 12. The intermediate portion 50 is inclined by an angle α2 with respect to a plane parallel to the foil 12. The angle α2 is less than the angle α1. In other words, the engagement portion 49 and the intermediate portion 50 have different inclinations from each other with respect to a plane Z-Y.

The coupling unit 150B further comprises a member 51 which is configured to form a connection hinge with a respective actuator 1052. The member 51 is interposed along the transverse axis Y between the left fork 42I and the right fork 42II. In use, the actuator 1052 is connected to the member 51 so as to selectively rotate the support 4 consequently causing the rotation also of the attachment T2.

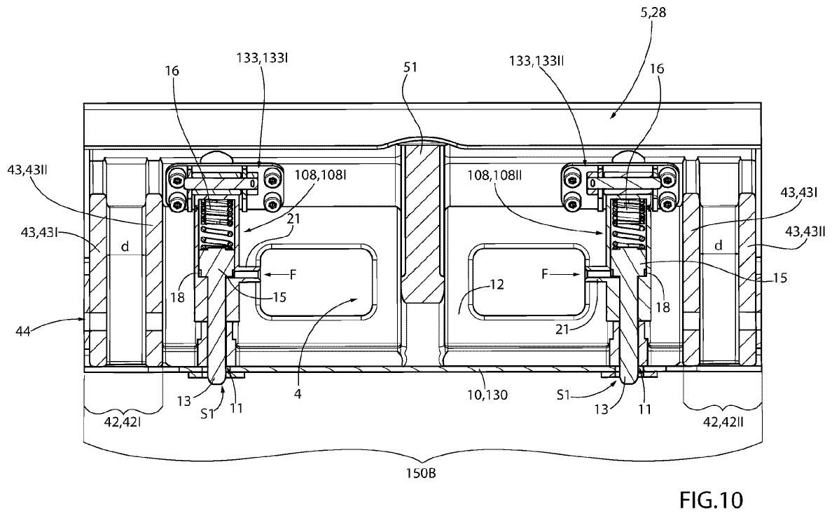

According to the example illustrated in FIGS. 7 to 10, the attachment-holder unit 5 comprises a foil body 28 which is folded so as to envelop, at least partially, respective portions of the support 4. In particular, the attachment-holder unit 5 comprises: a flat wall 128, having a perimeter substantially equal to that of the foil 12 of the support 4; an abutment wall 129 and an interference wall 130. The abutment wall 129 is inclined with respect to the flat wall 128 by an angle α3 so as to form a groove 109 (the function of which is comparable to the grooves 109 of the abutment elements 9 described in the foregoing). The interference wall 130 is substantially perpendicular to the flat wall 129. The angle α3 is substantially equal to the angle al of the engagement portion 49 of the support 4, so that in use the engagement portion 49 is in contact with the abutment wall 129. The flat wall 128, the abutment wall 129 and the interference wall 130 delimit a housing 131 which is configured to house a respective portion of the support 4.

Advantageously, the shape and the size of the housing 131 are such as to allow the insertion with clearance of the support 4. When the support 4 is inserted inside the housing 131, the abutment wall 129 faces the engagement portion 49 and is configured to come in contact against the latter. Advantageously, the inclination al of the engagement portion 49 is determined so as to allow the insertion of the vertex h1 of the support inside the housing 131.

The interference wall 130 constitutes the interaction unit 10. The interference wall 130 has seats 11, which in the illustrated case are two. According to a variation not illustrated, the interaction unit 10 can have a single seat 11 or three or more seats 11.

The coupling unit 6 comprises, in turn, a mechanism 108. In particular, the coupling unit 6 comprises a left mechanism 108I and a right mechanism 108II. The mechanisms 108I and 108II are single-acting hydraulic cylinders. The mechanisms 108I and 108II are substantially similar to those illustrated in the variation of FIGS. 1 to 6, the components in common maintain the same reference numerals and are illustrated without repeating them for brevity. Unlike the mechanisms 8 illustrated in FIGS. 1 to 6, the fitting 21 with the pressurized oil inlet F is lateral. In this case, the oil intake occurs directly into the expansion chamber 18. Unlike the example illustrated in FIGS. 1 to 6, the mechanism 108 does not have the central chamber 22 and the stem 19.

According to the illustrated example, the support 4 comprises a left bracket 133I and a right bracket 133II. The left bracket 133I is interposed between the left fork 42I and the member 51. The right bracket 133II is interposed between the member 51 and the right fork 42II.

The left mechanism 108I is fixed to the left bracket 133I. The right mechanism 108II is fixed to the right bracket 133II. Each mechanism 108I, 108II is hinged to the respective bracket 133I, 133II about an axis Y2 parallel to the transverse axis.

The pin 13 of each mechanism 108 protrudes downwards and is oriented so as to be inserted, in use, inside a respective seat 11 of the interference wall 130.

According to the example illustrated in FIGS. 8 to 10, the fitting 21 for the connection with the oil inlet radially protrudes outside the mechanism 108.

In use, the support 4 is fixed to the frame of the radio-controlled vehicle 104 and each mechanism 108 is connected to the hydraulic assembly (of known type and not illustrated) of the radio-controlled vehicle 1. The operator acting on the radio controller 104 selectively remotely adjusts the activation and the deactivation of the coupling unit 6 to selectively fix/release the attachment-holder unit 5 from the support 4. In other words, the attachment-holder unit 5 can be connected to the support 4 without the direct intervention of the operator.

The connection system 2 and the radio-controlled vehicle 1 described above allow operating safely in any operating condition, especially on extreme slopes, this is particularly advantageous also in case the attachment T should jam. Therefore, in such operating conditions, this guarantees the safety of the operator and at the same time the protection of the radio-controlled vehicle 1 which, through its release, prevents possible damage to the vehicle.

1. A method to connect an attachment to a radio-controlled vehicle by means of a connection system, which comprises a support, an attachment-holder unit and a coupling unit; wherein said support is configured to be fixed, in use, to a radio-controlled vehicle; wherein said attachment-holder unit is configured to be fixed, in use, to an attachment; wherein said coupling unit is configured to selectively connect to each other said support and said attachment-holder unit; wherein said coupling unit is remotely operable; the method comprising to dispose selectively and automatically, namely without the physical involvement of an operator, the coupling unit:
in a fixing configuration, wherein the attachment-holder unit and the support are fixed together;
in a release configuration, wherein the attachment-holder unit and the support are reciprocally movable.

2. A method according to claim 1, wherein said coupling unit comprises a hydraulic mechanism and is fed, in use, by a pressurized oil inlet;
wherein the operation of the coupling unit is function of flux parameters of the pressurized oil inlet, in particular pressure and/or flow rate.

3. A method according to claim 1 and comprising the step of remotely operating the movements of said support by means of said radio-controlled vehicle.

4. A connection system of an attachment to a radio-controlled vehicle; said connection system comprising a support, an attachment-holder unit and a coupling unit; wherein said support is configured to be fixed, in use, to a radio-controlled vehicle; wherein said attachment-holder unit is configured to be fixed, in use, to an attachment; wherein said coupling unit is remotely operable and is configured to be disposed selectively and automatically, namely without the physical involvement of an operator:
in a fixing configuration, wherein the attachment-holder unit and the support are fixed together;
in a release configuration, wherein the attachment-holder unit and the support are reciprocally movable.

5. A connection system according to claim 4, wherein said coupling unit comprises a hydraulic mechanism which is configured to drive, selectively, a coupling element, in particular a pin, from a fixing configuration, to a release configuration, and vice versa; in particular, said hydraulic mechanism is a push type single-acting hydraulic cylinder.

6. A connection system according to claim 5, wherein the fixing configuration of the pin is a rest position of said mechanism, namely a position taken when the hydraulic mechanism is not fed by a pressurized oil inlet.

7. A connection system according to claim 5, wherein said coupling unit comprises a plurality of said mechanisms.

8. A connection system according to claim 4, wherein said attachment-holder unit comprises an interaction unit which has one or more housings; each housing is configured to realize a shape coupling and/or an interference fit with a coupling element of a respective coupling unit.

9. A connection system according to claim 4, wherein said attachment-holder unit comprises one or more abutment elements configured to be in contact, in use, against a respective portion of said support; in particular, each abutment element has, or is bent to form, a slot configured to house a respective portion of the support; each slot faces towards, namely is accessible from, the interaction unit.

10. A connection system according to claim 9, wherein each coupling unit is fixed in a predetermined position of said support so as to be disposed between the interaction unit and the abutment elements.

11. A radio-controlled vehicle comprising a connection system according to claim 4.
